(19) United States
(12) Patent Application Publication
(10) Pub. No.: US 2018/0027805 A1
(43) Pub. Date: Feb. 1, 2018

(54) ACID HERBICIDE-CONTAINING COMPOSITIONS, PRECURSORS, DERIVATIVES, AND METHODS

(71) Applicant: Aguam LLC, Spokane, WA (US)

(72) Inventor: Scott K. Parrish, Spokane, WA (US)

(21) Appl. No.: 15/548,961

(22) PCT Filed: Feb. 5, 2016
(86) PCT No.: PCT/US16/16717

§ 371 Date: Aug. 4, 2017

Related U.S. Application Data
(60) Provisional application No. 62/113,237, filed on Feb. 6, 2015.

(51) Int. Cl. A01N 25/30; A01N 31/12; A01N 59/02; A01N 33/08; A01N 37/40; A01N 39/02; A01N 25/02; A01N 33/04

(52) U.S. Cl. CPC A01N 25/30; A01N 25/02; A01N 31/12; A01N 33/04; A01N 33/08; A01N 37/40; A01N 39/02; A01N 59/02; A01N 2300/00

(57) ABSTRACT

Herbicide compositions that include herbicide concentrate compositions (“concentrates”) and “herbicide application compositions,” as well as precursors thereof, derivatives thereof, as methods of preparing and using these compositions, the herbicide compositions containing acid herbicide, amine surfactant, and inorganic acid. The following description relates to herbicide compositions such as herbicide concentrates and herbicide application compositions, as well as compositions that are precursors to these compositions or derivatives of these compositions, and related methods.

### CROSS REFERENCE TO RELATED APPLICATION

This application claims priority to U.S. Provisional Application No. 62/113,237, filed on Feb. 6, 2015, titled “HERBICIDE COMPOSITION” which is incorporated herein by reference in its entirety.

### FIELD OF THE INVENTION

The invention relates to herbicide compositions that include herbicide concentrate compositions (“concentrates”), “herbicide application compositions,” as well as precursor compositions, derivatives of these compositions, and methods of preparing and using these compositions, the herbicide compositions containing acid herbicide, amine surfactant, and inorganic acid.

### BACKGROUND

Commercially available herbicide compositions include a very large variety of herbicidally-active chemical compounds. Examples include those of the general class known as phenoxy herbicides, e.g., 2,4-dichlorophenoxyacetic acid (known as 2,4-D), MCPA acid, MCPP acid; those of the general class known as pyridine herbicides, (e.g., triclopyr, fluoroxypyr); those of the general class of benzoic acid herbicides, (e.g., dicamba acid); those of the general class of aryloxy phenoxy propionic acid herbicides, (e.g., fluazifop acid and quizolofop acid); water-insoluble diphenyl ether type herbicides (e.g., oxyfluorfen or acifluorfen); glyphosate compounds (N-(phosphonomethyl)glycine), e.g., in the acid form, referred to as glyphosate acid, or in a salt form such as the IPA salt form; imidizole herbicide compounds (e.g., imazapyr or imazaquin); as well as others.

For practical reasons, herbicide compounds are produced and sold in the form of a concentrate, meaning a commercial herbicide composition containing a high concentration of active herbicide compound, adapted for commercial transport, distribution, and sale. The concentrate can be combined with water by an end user (farmer or grower) to produce a diluted composition, i.e., a “herbicide application composition,” that can be evenly applied to a field. Examples of concentrated commercial herbicide materials include those referred to as wettable powders, water dispersible granules, granules, aqueous solutions, water soluble powders, emulsifiable concentrates, oil-based flowables, concentrated emulsions, suspoemulsions, emulsions, suspensions, suspension concentrates, mixtures, dispersions, and microemulsion-forming-concentrates, as well as others. Any of these different concentrate types may have different advantages or disadvantages based on factors such as the mode of application, requirements for mixing and diluting the concentrate, and efficacy of active ingredient included in the herbicide composition.

The phenoxy acid herbicide 2,4-D (i.e., 2,4-dichlorophenoxyacetic acid) is one of the most common herbicides in the world. This herbicide came to market in 1945. It is commonly formulated and commercially available in two major forms: as an amine salt of 2,4-D (e.g., the dimethylamine salt), and as a low volatile (LV) ester of 2,4-D. Amine salts can be soluble in water and are prepared commercially in aqueous concentrate forms. Low volatile esters are oils and are formulated as emulsifiable concentrates. The 2-4,D amine salt formulations are less herbicidally-active than the low volatile esters. However, the amine salts are also much less volatile. The amine salts have less chemical trespass liability and are considered more environmentally friendly.

Recently, 2,4-D has been commercially available in the acid compound form, meaning a protonated compound as compared to an esterified or salt (e.g., amine salt) form. These 2,4-D acid formulations can be characterized by low volatility and increased herbicidal activity, both being obvious advantages. The unit activity of these acid formulations can be as much as twice the activity of the amine salts, even activity that is similar to the low volatile 2,4-D ester formulation. The volatility of the 2,4-D acid formulations may be lower than that of an amine salt formulation, and much lower than the low volatile ester formulations.

Yet these 2,4-D acid formulations also have certain drawbacks such as inconsistent performance and difficulty in producing a highly-loaded concentrate. Inconsistent performance of commercial 2,4-D acid products can occur because it is difficult to control the pH of a herbicide application composition prepared by diluting the 2,4-D acid concentrate, e.g., a diluted spray solution prepared by mixing available water (“spray water”) with the concentrate in a tank. When a 2,4-D acid concentrate is diluted with the water, inorganic acid can also be combined with the concentrate to reduce the pH of the diluted solution to below the pKₐ of the acid herbicide compound, which is approximately 2.8 for 2,4-D. If the pH of the diluted solution is not held below the pKa of the 2,4-D acid compound, the 2,4-D acid compound will combine with a cation available in the spray water and form a salt, which is not as effective as the acid herbicide form. For example, if the solution is prepared from water that contains a high level of cations (i.e., “hard” spray water), the 2,4-D molecules combine with the hard water cations and form a salt that is then applied to a field. By failing to have a solution pH below 2.8 when applied, a user of the 2,4-D acid concentrate has lost a substantial degree of efficacy associated with the acid form of the 2,4-D. Often, a user may apply a 2,4-D acid herbicide to a field and the herbicide will be less effective than what was expected by the user. The reason may be that the user did not appreciate the need to keep the pH of the herbicide at a level that was sufficiently low keep the herbicide compound in the acid form, and avoid forming the salt.

### SUMMARY

The following description relates to herbicide compositions such as herbicide concentrates and herbicide application compositions, as well as compositions that are precursors to these compositions or derivatives of these compositions, and related methods.

The herbicide concentrates (or simply “concentrates,” for convenience) include a herbicide compound in acid form, amine surfactant, optional diluent, and inorganic acid (preferably a concentrated acid), and can preferably contain not more than a small amount of water. Other ingredients such as additional surfactant, emulsifier, preservatives, etc., as are useful for a herbicide application composition (e.g., tank mix) may also be included in low amounts.

The concentrate contains inorganic acid in an amount sufficient to cause the concentrate to be self-buffering, meaning that the concentrate can be combined with multiple times its own volume of water (e.g., “spray water” used to prepare a tank mix), and the resultant composition will have a low pH, for example a pH that is below 5, 4, 3, or 2. A preferred self-buffering concentrate can be combined with multiple times its own volume of water (e.g., 3, 5, 7, 10, 20, or 30 or more times its own volume of water), with the combined water and concentrate having a pH that is below the pKₐ of acid herbicide compound that is present in the concentrate.

The inorganic acid may be any of a variety of suitable inorganic acids capable of forming a self-buffering concentrate when combined with the amine surfactant, acid herbicide, and optional diluent. The inorganic acid (as an ingredient) may be of any useful concentration, such as a “concentrated” acid, but to reduce the amount of water in the concentrate or a precursor to the concentrate, a preferred inorganic acid can be of a type referred to as a “concentrated acid,” or may otherwise contain a relatively low amount of water.

Preferred herbicide concentrate compositions can contain a small amount of water present in the inorganic acid ingredient, very little if any water present in the amine surfactant ingredient, the optional diluent ingredient, and the active herbicide compound ingredient, and preferably no other water added separately as part of any additional ingredient. A resulting concentrate can preferably contain not more than 10, 5, 3, 2, or 1 percent water based on the total weight of the concentrate. This includes water from any source, such as water contained in a liquid ingredient such as the inorganic acid.

The concentrate, containing a concentrated amount of acid herbicide, amine surfactant, optional diluent, and an amount of inorganic acid to cause the concentrate to be self-buffering, can be prepared by any method and by combining these ingredients in any useful order. According to certain methods, the concentrate can be prepared by first combining an amount of amine surfactant and optional diluent with an amount of the acid herbicide, this step being performed in the presence of a low amount of water and optional heating. In specific, the acid herbicide may be first dissolved in the amine surfactant and optional diluent in the presence of a low amount of water. According to useful methods, the amount of water present in the amine surfactant, the amount of water in the diluent, the amount of water present in the acid herbicide, and the amount of water otherwise present when combining these ingredients, is a low amount, e.g., a minimum amount, and each ingredient preferably contains no water or nearly no water. Subsequently, after combining the acid herbicide and amine surfactant and optional diluent, inorganic acid is added to the combination of amine surfactant, optional diluent, and acid herbicide.

According to alternate methods, a concentrate can be prepared by first combining an amount of amine surfactant and optional diluent with an amount of inorganic acid, this step being performed in the presence of a low amount of water. In specific, the inorganic acid may be first combined with the amine surfactant and optional diluent in the presence of a low amount of water, to produce a solution of these ingredients. According to useful methods, the amount of water present in the amine surfactant, the amount of water in the diluent, the amount of water present in the inorganic acid, and the amount of water otherwise present when combining these ingredients, is a low amount, e.g., a minimum amount, e.g., less than 10 or less than 5 weight percent based on total weight of all ingredients. Each of the amine surfactant ingredient and the optional diluent ingredient preferably contains no water or nearly no water. The inorganic acid can preferably be a concentrated acid. Subsequently, after combining the inorganic acid and the amine surfactant and optional diluent, acid herbicide compound and additional ingredients such as additional diluent can be added to the combination of amine surfactant, optional diluent, and inorganic acid.

According to these embodiments, a solution that results from combining the inorganic acid, amine surfactant, and optional diluent, has been observed to exhibit advantageous behavior when subsequently combined with other organic materials. In specific, while the resultant solution (surfactant-inorganic acid solution) is highly acidic and contains concentrated acid, it can be possible to combine such a surfactant-inorganic acid solution with additional organic materials, without the additional organic materials being destroyed or unduly degraded by the acid. The amine surfactant, e.g., tallow amine, has the effect of protecting subsequently added organic materials such as diluent or acid herbicide, from the inorganic acid, thereby allowing for the surfactant-inorganic acid solution to be advantageously combined with added organic materials to produce a concentrated herbicide composition.

In one aspect, the invention relates to a herbicide concentrate composition that includes amine surfactant, inorganic acid, acid herbicide, and less than 10 weight percent water. The concentrate preferably is self-buffering and can preferably include a high concentration of the acid herbicide, such as at least 2, 2.5, 3, 3.5, 4, or 5 pounds per gallon, or more.

In another aspect, the invention relates to a herbicide application composition comprising a herbicide concentrate composition as described herein and from 2 to 30 gallons added water per gallon herbicide concentrate composition.

In yet another aspect, the invention relates to a method of preparing a herbicide concentrate composition. The method includes: providing amine surfactant and optional diluent, providing acid herbicide, providing inorganic acid, and combining the amine surfactant with the acid herbicide and inorganic acid to produce a herbicide concentrate composition.

In another aspect, the invention relates to a surfactant-acid herbicide solution that includes: from 20 to 70 parts by weigh amine surfactant, and from 20 to 70 parts by weight acid herbicide, based on 100 parts by weight amine surfactant and acid herbicide, the solution containing not more than 5 weight percent water.

In yet another aspect, the invention relates to a surfactant-inorganic acid solution that includes: from 70 to 97 parts by weigh amine surfactant, and from 3 to 30 parts by weight inorganic acid, based on 100 parts by weight amine surfactant and acid herbicide, the solution containing not more than 10 weight percent water.

### BRIEF DESCRIPTION OF THE DRAWINGS

FIGS. 1, 2, and 3 represent efficacy data and comparative efficacy data relative to compositions as described.

### DETAILED DESCRIPTION

The following described herbicide compositions include those prepared in the form of a concentrate, as well as those in the form of a herbicide application composition prepared from one of the described concentrates by combining the concentrate with multiple times its volume of water. Also described are precursor compositions, preferably solutions, that include concentrated amounts of amine surfactant, optional diluent, and acid herbicide, or that include concentrated amounts of the amine surfactant, optional diluent, and inorganic acid.

As used herein, a “concentrate” refers to a liquid composition prepared from and containing a combination of ingredients that includes acid-form herbicide compound, amine surfactant capable of containing the acid-form herbicide in solution, inorganic acid, optional diluent, other optional adjuvants present in low amounts, and preferably a low amount of water. As described in more detail herein, preferred concentrates are non-aqueous solutions that are substantially free of precipitates, substantially free of coagulation, non-phase separated, that are flowable (pourable and preferably pumpable, e.g., at 72 degrees Fahrenheit), and that can combine with water to form a flowable (pourable, pumpable, and sprayable, e.g., at 72 degrees Fahrenheit) aqueous composition suitable for application by spraying onto a crop, plant, or weed. The concentrate can be clear (color-less) or colored and transparent, and should not be cloudy, phase separated, or contain crystals, undissolved solids, or precipitate. Preferred concentrates are storage-stable for weeks (up to 12 weeks) or months (up to 3, 4, 5, or 6 months) at ambient temperature (72 degrees Fahrenheit) (preferably up to 90 or 100 F) without forming precipitate, without coagulation, and remain in a form that is flowable (pourable and pumpable, e.g., at 72 degrees Fahrenheit) and water miscible.

A preferred concentrate can exhibit a viscosity that allows the concentrate to be transported by hoses and a pump, i.e., that is “pumpable.” At 70 degrees Fahrenheit, the viscosity of a concentrate can be below that of water (1 centipoise (cps), as a reference for the viscosities of the present disclosure), but may typically be above the viscosity of water and below a viscosity of 10,000 cps (approximate viscosity of honey), below a viscosity of 5,000 cps (approximate viscosity of Karo syrup), below a viscosity of 1,000 (Castor oil), or below a viscosity of 900 or 700 cps (approximate viscosity of SAE 40 motor oil or glycerin), optionally below a viscosity of 600 or 500 cps. Optionally a precursor of the concentrate such as a surfactant-inorganic acid solution or a surfactant-herbicide acid solution can also exhibit a viscosity that allows the solution to be pumpable, e.g., as specified.

The acid-form herbicide (also referred to as “acid herbicide” or “acid-form herbicide compound”) is a herbicide compound that includes an acidic hydrogen atom that can be removed or replaced depending on environmental pH. One characteristic of an acid-form herbicide compound is pKa, which is understood to refer to the negative logarithm (base 10) of the equilibrium constant K for the reaction of the herbicide compound between its de-protonated form and its neutral form. Exemplary herbicide compounds that are capable of existing in an acid form can have a pKa below about 6, or below about 5, 4, or 3, or 2. Acid herbicides are chemically different from salts and esters of otherwise comparable herbicide compounds, such salts and esters also being typical and well known of many herbicide compounds that are capable of existing in an acid form. Examples of acid herbicide compounds are known in the chemical and agricultural chemical arts and are described, for example, in U.S. Pat. No. 6,906,004.

Some examples of useful herbicide compounds that can be used in an acid form include the following, some or all of which are commercially available in their acid form. For herbicide compounds that are sold in forms other than the acid form, such as a salt or ester form, a chemist of ordinary skill will understand how to convert the non-acid to an acid form for use as described herein.

The class of phenoxy herbicides generally includes herbicides derived from chlorinated phenols, and includes herbicide compounds that can exist in an acid form. Examples include the well known herbicides 2,4-dichlorophenoxyacetic acid (known as 2,4-D), 4-methyl-4-chlorophenoxyacetic acid (MCPA Acid), and 2(-2-methyl-4-chlorophenoxy)propionic acid (MCPP acid), as well as others.

Pyridine herbicides are herbicides derived from a pyridine ring-containing compound, and include herbicide compounds that can exist in an acid form. Examples include 3,5,6-trichloro-2-pyridyloxyacetic acid (triclopyr acid) and fluroxypyr (4-amino-3,5-dichloro-6-fluoro-2-pyridyloxyacetic acid), as well as others.

Benzoic acid herbicide compounds include or are derived from benzoic acid compounds. This class of herbicide compounds includes herbicide compounds that can exist in an acid form. A single example is dicamba acid (3,6-dichloro-O-anisic acid), but others could also be used according to the present description.

Aryloxy phenoxy propionic acid herbicide compounds (also referred to sometimes as “oxyphenoxy” herbicides), are another class of herbicide compounds that can exist in an acid form. Examples of specific compounds include fluazifop acid, quizolofop acid, as well as others.

Imidazolinones are still another class of herbicide compounds that can exist in acid form, with specific examples including imazethapyr acid, imazaquin acid, imazapyr acid, imazamethbenz acid, imazapic acid, and imazamox acid.

Table 1 lists some examples of acid herbicide compounds with pKa values.

TABLE 1

| | | | | | |
|---|---|---|---|---|---|
| Acid Herbicide | pKa | Salt Form | Clopyralid | 2.3 | monoethanolamine |
| Bromoxynil | 4.06 | | Floroxypyr | | |
| Ioxynil | 3.96 | | Quinclorac | 4.34 | |
| Bentazon | NA | sodium | Quizalofop-p | NA | |
| Dicamba | 1.87 | diglycolamine | Sethoxydim | 4.16 | |
| | | diethylamine | 2,4-D | 2.8 | sodium |
| Diclofop | 3.57 | | | | ammonium |
| Fenoxaprop | NA | | | | triethanolamine |
| Fluazifop-p | 2.98 | | | | dimethylamine |
| Fosamine | NA | | 2,4-DB | 4.8 | |
| Glufosinate | 2, | ammonium | Dichlorprop | 2.86 | Dimethylamine- |
| | 2.9 | | | | |
| Glyphosate | 2.6, | Isoproplyamine | MCPA | | |
| | 5.6 | | | | |
| Haloxyfop | 4.33 | | Mecoprop | | |
| | | | (MCPP) | | |
| Imazamethbenz | 2.9 | | Clethodim | | |
| Imazapyr | 2.3 | Isoproplyamine | Sethoxydim | | |
| Imazaquin | 3.8 | ammonium | Acifluorfen | 3.86 | sodium |
| Imazamox | | | Dacthal | | |
| Imazethapyr | 3.9 | ammonium | Endothal | | |
| Picloram | 2.3 | triisopropanolamine | Alanap | | |
| Triclopyr | 2.68 | triethylamine | Asulam | 4.82 | |

(Where a pKa is not listed, a skilled artisan would be able to identify the pKa.)

The acid herbicide can be in any form useful to prepare a concentrate as described, such as in the form of a solid flake, pellet, or granule that contains a high concentration of the acid herbicide and a low amount of water, such as less than 5, 2, or 1 percent water based on the total weight of the acid herbicide ingredient.

The concentrate contains amine surfactant of a type and in an amount that is sufficient to dissolve (e.g., by itself or optionally in the presence of a diluent) an amount of acid herbicide that is useful to form a concentrate as described, the dissolution optionally being in the presence of heat and preferably in the absence of water or in the presence of not greater than a low amount of water, as described.

As used herein, a “surfactant” is an organic compound that lowers the surface tension (or interfacial tension) between two liquids or between a liquid and a solid, typically an organic amphiphilic compound that contains a hydrophobic group (e.g., a hydrocarbon (e.g., alkyl) “tail”) and a hydrophilic group. An “amine surfactant” is a surfactant that includes an amine group.

Exemplary amine surfactants can include an amine group such as octyl amine, lauryl amine, stearyl amine, oleyl amine, tallow amine, cetylamine, N-tetradecyl amine, cocoamine, hydrogenated tallow amine, di(hydrogenated) tallow amine, dicocoalkyl amine, N-tridecyltridecanamine, N-methylstearylamine, distearyl amine, and dialkyl (C₈-C₂₀) amine.

Certain preferred amine surfactants for use in the described concentrates include cationic amine surfactants, meaning surfactants that are cationic at conditions (including pH) of a herbicide application composition. Examples include alkyl dimethylamines.

Other examples of amine surfactant include tallow amine surfactant, for example ethoxylated tallow amine (e.g., polyoxyethyleneamine or POEA), and the following.

Alkyl amine surfactants are known and commercially available, including polyalkoxylated amine surfactants, for example polyoxyethyleneamine (POEA) surfactants. See, e.g., U.S. Pat. No. 5,668,085 to Forbes et al., the entirety of which is incorporated herein by reference, which describes polyoxyethylene C₈₋₂₂ alkylamine surfactant having an average of up to about eight oxyethylene units per molecule. These can be represented by the formula:

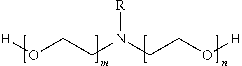

where R represents a straight- or branched-chain alkyl or alkenyl group having from about 8 to about 22 carbon atoms, and n and m are integers such that n+m has a value of about 2 to about 8, including mixtures of such amines having different groups R, the average number of carbon atoms in the groups R being from about 8 to about 22, also including a mixture of such amines having different values of n and m, n and m being integers such that the average value of n+m in the mixture is about 2 to about 8, R having a single value or an average value as in a mixture.

U.S. Pat. No. 5,317,003 to Kassebaum & Berk (incorporated herein by reference) describes compositions that contain a quaternary polyoxyethylene C₆₋₁₄ di-alkylammonium surfactant having about 5 to about 50 oxyethylene units per molecule. U.S. Pat. No. 5,652,197 to Claude et al. (also incorporated herein by reference) describes quaternary polyoxypropylene oxyethylene tri-(C₁₋₃ alkyl)ammonium surfactants having 2 to 20 oxypropylene units per molecule. U.S. Pat. No. 5,118,444 (incorporated herein by reference) to Nguyen describes polyoxyethylene C₆₋₂₀ alkylamine oxide surfactants having about 5 to about 25 oxyethylene units per molecule. U.S. Pat. No. 5,750,468 to Wright (incorporated herein by reference) describes compositions that contain a polyoxyethylene tertiary alkyletheramine, polyoxyethylene quaternary alkyletherammonium, or polyoxyethylene alkyletheramine oxide surfactant.

The amine surfactant can be in the form of or a part of an ingredient that is liquid at ambient temperature, such as at from 20, 30, or 40 to 70, 90, 100, 120, or 140 degrees Fahrenheit, containing a high concentration of amine surfactant compound, such as at least 70, 80, 90, or 95 percent amine surfactant compound, and a low amount of water, such as less than 5, 2, or 1 percent water based on the total weight of the amine surfactant ingredient. The chemistry of the amine surfactant can be selected to be compatible with a selected acid herbicide compound, so that the acid herbicide compound can be combined, at a high concentration, with the amine surfactant and optional diluent. Certain examples of amine surfactant compounds can be combined with a high concentration of acid herbicide to form a surfactant-acid herbicide solution as described herein, i.e., a liquid solution of the liquid amine surfactant (and optional diluent) and a high concentration of the acid herbicide dissolved in the liquid amine surfactant and optional diluent, the liquid solution preferably being stable. Alternately, a preferred amine surfactant compound can be combined with a high concentration of inorganic acid to form a surfactant-inorganic acid solution as described herein, i.e., a liquid solution of the liquid amine surfactant (and optional diluent) and a high concentration of inorganic acid, the liquid solution preferably being stable.

The amount of amine surfactant in a herbicide concentrate composition as described can be any amount effective (optionally in combination with diluent) to provide a concentrate as described, preferably containing a high concentration of acid herbicide, and that is stable, flowable or pourable across a range of ambient temperatures, and self-buffering. Example concentrates can contain amine surfactant in an amount in a range from 10 to 50 parts by weight, e.g., at least or in excess of 15, 20, 30, or 40 parts by weight, based on 100 parts by weight concentrate.

A solution or concentrate as described can also include diluent in combination with the amine surfactant. A diluent can be included as a liquid ingredient that will reduce the viscosity of a solution as described, while still allowing for a concentrate that has the form of a solution that exhibits stability and a self-buffering property. A diluent can be any organic (non-water) material that, when included in a solution or concentrate as described herein (e.g., a combination of combination of the amine surfactant, acid herbicide, and inorganic acid), reduces the viscosity of the solution or concentrate, especially to allow the solution or concentrate to be flowable and pumpable at ambient temperature (e.g., 72 degrees Fahrenheit), while the solution or concentrate still remains in the form of a stable solution free of precipitate and phase separation.

The diluent can be any organic material that can form a solution or concentrate as described, not containing precipitation or phase separation, that reduces the viscosity of the solution or concentrate, and that allows the resultant solution or concentrate to contain a high concentration of dissolved acid herbicide and desired stability and viscosity properties. A diluent can preferably be liquid at room temperature and over a range of temperatures from about 20, 30, or 40 to 70, 90, 100, 120, or 140 degrees Fahrenheit. A preferred diluent also has a viscosity that is below a viscosity of the amine surfactant (when similarly measured) such that the presence of the diluent in a concentrate or a solution that contains a concentrated amount of the amine surfactant will result in a reduced viscosity of the concentrate or solution.

Examples of diluents include liquid oils, alcohols (e.g., alkyl alcohols), polyols (e.g. glycols), non-ionic surfactants, and other organic compounds that exist in a liquid, that have a viscosity that will reduce a viscosity of a solution as described herein, and that when combined with amine surfactant are effective to dissolve a desirably high concentration of acid herbicide compound. Diluent can be in the form of a concentrated ingredient that contains a single diluent compound or a combination of two or more diluent compounds, preferably in the absence or substantial absence of water, e.g., a diluent ingredient can preferably contain up to or in excess of 70, 75, 80, 90, 95, 98, or 99 weight percent diluent material (a single type, or a combination of two or more diluent material), preferably less than 30, 25, 20, 10, 5, 2, or 1 weight percent non-diluent material, e.g., less than 10, 5, 2, or 1 weight percent water.

Examples of oils as diluent include essential oils, crop oil concentrates, mineral oil, vegetable oil, biodiesel, methylated seed oil, ethoxylated oil, peptoil crop oil concentrate, DEG crop oil concentrate, crop oil (petroleum) concentrate, and the like, any of which may be part of a larger ingredient that contains the oil in combination with surfactant, emulsifier, or another minor ingredient, preferably with a low amount of water.

Examples of alcohol and polyol diluents include lower alkyl alcohols such as C2 to C8 alcohols, which may be straight or branched; alkylene glycols and dialkylene glycols such as glycerol, ethylene glycol, propylene glycol, and diethylene glycol; or combinations of two or more of these.

The amount of diluent in a herbicide concentrate composition as described can be an amount that, in combination with the amine surfactant, is effective to provide a concentrate as described, preferably containing a high concentration of acid herbicide compound, and that is also stable, self-buffering, and exhibits desired viscosity. Example concentrates can contain diluent in an amount in a range from 1 or 2 to 25, or 30 parts by weight diluent, e.g., at least or in excess of 5, 10, 15, or 20 parts by weight diluent, based on 100 parts by weight concentrate. Example concentrates can contain a combined amount of diluent and amine surfactant in an amount in a range from 10 to 50 parts by weight, e.g., at least or in excess of 15, 20, 30, or 40 parts by weight diluent and amine surfactant, based on 100 parts by weight concentrate. In a manner consistent with the foregoing, exemplary relative amounts of diluent and amine surfactant in a concentrate or a solution can be from about 5 to 70, e.g., 10 to 60, or 20 to 50 parts by weight diluent per 95 to 30, 90 to 40, or 80 to 50 parts by weight amine surfactant, based on 100 parts by weight total diluent and amine surfactant in a solution or concentrate as described.

The concentrate includes inorganic acid in an amount sufficient to cause the concentrate to be self-buffering. The inorganic acid may be any of a variety of suitable inorganic acids capable of forming a self-buffering concentrate when combined with the surfactant-acid herbicide solution. The inorganic acid may be of any useful concentration, but to reduce the amount of water in the concentrate, a preferred inorganic acid can be of a type referred to as a “concentrated acid,” or may otherwise contain a relatively low amount of water.

Concentrated acids are acids that contain a high or maximum amount of acid material in the presence of a low or minimum amount of water possible for the particular acid, and that do not contain a substantial amount of other materials, e.g., less than 5, 3, 2, or 1 percent of materials other than the acid and water. Examples of known concentrated acids include concentrated forms of sulfuric acid, phosphoric acid, hydrochloric acid, nitric acid, acetic acid (e.g., “glacial” acidic acid), perchloric acid, and polyphosphoric acid. Different inorganic acids are capable of being combined with different minimum amounts of water in a concentrated form. The following table shows some examples of acids considered to be concentrated, and representative molar concentrations. See Table 2.

TABLE 2

| | |
|---|---|
| Acetic Acid, glacial, 100% | 17 Molar |
| Hydrochloric Acid, 37% | 12 Molar |
| Nitric Acid, 70% | 16 Molar |
| Phosphoric Acid, 85% | 15 Molar (45 Normal) |
| Perchloric Acid, 71% | 11 Molar |
| Sulfuric Acid, 96% | 18 Molar (36 Normal) |

To be considered “concentrated” or to otherwise be considered to contain a relatively low amount of water, according to this description, an acid is not required to contain an absolute minimum amount of water that can be present in a particular type of acid. Instead, an acid is considered to be concentrated or to contain a relatively low amount of water if the amount of water in the acid is in a range that approaches the minimum amount that can be present, e.g., within 5, 10, or 20 percentage points from the minimum (the minimum amount being the same as the concentration of water in the “concentrated” form of an acid). As an example to illustrate the meaning of these ranges, an amount of water that is sometimes understood to be a minimum in sulfuric acid is 2 or 4 percent (i.e., in 96 or 98 percent concentrated sulfuric acid). Sulfuric acid having an amount of water that is within 20 or 10 percentage points of this minimum water content includes sulfuric acid having up to 22 or 24 percent water (i.e., 76 or 78 percent sulfuric acid), and sulfuric acid having up to 12 or 14 percent water (i.e., 86 or 88 percent sulfuric acid), respectively.

Examples of acids that are also considered to be “concentrated acids” include water combined with acid in the following acid concentrations: sulfuric acid that is more than 90 percent concentrated, perchloric acid that is more than 50 percent concentrated, hydroiodic acid that is more than 40 percent concentrated, hydrobromic acid that is more than 50 percent concentrated, hydrochloric acid that is more than 25 percent concentrated, and nitric acid that is more than 60 percent concentrated.

Stated differently, the inorganic acid can be concentrated to include a minimum amount of water for the type of the acid, or may be a concentrated acid that is diluted with some amount of water, e.g., 10, 20, 25, or 30 weight percent water based on the total weight of the concentrated acid and water added for the dilution. The amount of water added to the concentrated acid should not be so high that the water will cause an adverse effect in a herbicide concentrate prepared by combining the (water-containing) inorganic acid with the surfactant and the acid herbicide.

A solution or concentrate of the present description, which includes precursors of a herbicide concentrate composition as described, can be made to include a combination of two or more of amine surfactant, diluent, inorganic acid, and acid herbicide. Various method of preparing a herbicide concentrate composition can include combining the different ingredients in any of various orders. Thus, during preparation of a concentrate, certain embodiments of solutions as described herein can be in the form of liquid amine surfactant and optional diluent combined with acid herbicide to form a combination (i.e., solution) that contains a high amount of the acid herbicide and a high amount of the amine surfactant, diluent, or both, with low amounts of other ingredients and a low or very low amount of water. This combination of the acid herbicide, the amine surfactant, and optional diluent, is referred to herein as a “surfactant-acid herbicide solution.”

According to some such embodiments of solutions as described herein, the liquid (at ambient temperature) amine surfactant and optional diluent can be selected to be capable of dissolving (optionally with heat applied to the amine surfactant) a relatively high amount of acid herbicide into the amine surfactant and optional diluent, to form a surfactant-acid herbicide solution that contains at least 10, 20, 30, 40, 50, 60, or 70 parts by weight acid herbicide per 25, 30, 40, 50, 60, 70, 80, or 90 parts by weight amine surfactant and optional diluent, such as up to or in excess of 30, 40, or 50 parts by weight acid herbicide per 20, 30, 40, 50, or 60 parts by weight amine surfactant and diluent.

Examples of surfactant-acid herbicide solutions may consist of acid herbicide (one or a combination of two or more) dissolved in amine surfactant (one or more) and optional diluent, meaning that no ingredient other than the acid herbicide, amine surfactant, and optional diluent, is present (allowing for small amounts of impurities that may be present in each of these ingredients). Other examples of surfactant-acid herbicide solutions may consist essentially of the acid herbicide dissolved in the amine surfactant and optional diluent, meaning that the surfactant-acid herbicide solution contains at least 90, 95, 98, 99, or 99.5 weight percent of the acid herbicide, amine surfactant, and optional diluent, and a total of below about 5 weight percent, e.g., less than 3 or 2 weight percent, or less than 1 or 0.5 weight percent of other ingredients (such as water). Preferred surfactant-acid herbicide solutions contain a low amount of water, such as below 5, 2, 1, or 0.5 weight percent water. These numbers again allow for small amounts of impurities that may be present in an ingredient that contains the acid herbicide or the surfactant, the impurities being residual materials present due to commercial manufacturing processing of the ingredient.

### Example Surfactant-Acid Herbicide Solutions

| | | |
|---|---|---|
| | | Example ranges |
| | | (parts by weight based |
| | | on 100 parts by |
| | Example | weight of these listed |
| Ingredient | ingredient | ingredients) |

| | | | |
|---|---|---|---|
| Amine Surfactant | Tallow amine | 25 to 70 | 30 to 60 |
| Diluent | Glycol, e.g., | 1 to 35 | 5 to 30 |
| | diethylene glycol | | |
| Herbicide Acid | 2,4-D | 30 to 75 | 35 to 60 |
| Total of these | | 100 | 100 |
| listed ingredients | | | |

According to certain methods of preparing a herbicide concentrate composition by first preparing a surfactant-acid herbicide solution, the surfactant-acid herbicide solution can be combined with a desired amount and type of inorganic acid to produce the herbicide concentrate composition.

Various other methods of preparing a herbicide concentrate composition can include a step of directly combining the amine surfactant and optional diluent with the inorganic acid. Thus, during preparation of a concentrate, certain embodiments of solutions as described herein can be in the form of liquid amine surfactant and optional diluent, combined with inorganic acid (e.g., concentrated inorganic acid, such as concentrated sulfuric acid). This solution preferably contains a high amount of the amine surfactant, diluent, or both, and a lower amount of the inorganic acid, with low amounts of other ingredients and water. This combination of the acid herbicide and the amine surfactant is referred to herein as a “surfactant-inorganic acid solution.”

According to a related aspect of these solutions and methods, it has been discovered that inorganic acid, e.g., concentrated acid such as concentrated sulfuric acid, can be combined with a concentrated amount of amine surfactant (e.g., a tallow amine surfactant) and optional diluent (e.g., glycol such as diethylene glycol), by slowly adding the acid to the surfactant and optional diluent, in the presence of a low amount of water, e.g., less than 20, 15, 10, 5, 2, or 1 weight percent water based on the total amount of water in the surfactant, diluent, and inorganic acid ingredients. It has now been observed that the resultant acidic solution can be combined with added organic materials such as acid herbicide, or other diluents, surfactant, or emulsifier, without the acid causing undue harm or degradation to the added organic material.

According to some embodiments of surfactant-inorganic acid solutions as described herein, the liquid (at ambient temperature) amine surfactant can be selected to be capable of combining with (optionally with heat applied to the amine surfactant) an inorganic acid, to form a surfactant-inorganic acid solution that contains from about 3 or 5 to 30, e.g., 7 to 20, or 10 to 15 parts by weight inorganic acid, per 70 to 97 or 95, 80 to 93, or 85 to 90 parts by weight amine surfactant and optional diluent, based on 100 parts by weight total inorganic acid, surfactant, and optional diluent.

Examples of surfactant-inorganic acid solutions may consist of inorganic acid, amine surfactant (one or more), and optional diluent, meaning that no ingredient other than the inorganic acid, amine surfactant, and optional diluent is present (allowing for small amounts of impurities that may be present in each of these ingredients, and allowing for some water in the inorganic acid but very low amounts of water in the amine surfactant and optional diluent). Other examples of surfactant-inorganic acid solutions may consist essentially of inorganic acid, amine surfactant, and diluent, meaning that the surfactant-inorganic acid solution contains at least 90, 95, 98, 99, or 99.5 weight percent of the inorganic acid (including any water in this ingredient), amine surfactant, and optional diluent, and a total of below about 5 weight percent, e.g., less than 3 or 2 weight percent, or less than 1 or 0.5 weight percent of other ingredients (such as added water). Preferred surfactant-inorganic acid solutions contain a low amount of total water from any source, such as below 10, 5, 2, 1, or 0.5 weight percent water. These numbers again allow for small amounts of (non-water) impurities that may be present in an ingredient the inorganic acid, amine surfactant, or diluent, the impurities being residual materials present due to commercial manufacturing processing of the ingredient.

### Example Surfactant-Inorganic Acid Solutions

| | | Example ranges | |
|---|---|---|---|
| | | (parts by weight based | |
| | | on 100 parts by | |
| | Example | weight of these listed | |
| Ingredient | ingredient | ingredients) | |
| Amine Surfactant | Tallow amine | 70 to 97 | 75 to 96 |
| Diluent | Glycol, e.g., | 1 to 45 | 5 to 35 |
| | diethylene glycol | | |
| Concentrated Acid | Concentrated | 3 to 30 | 4 to 25 |
| | sulfuric acid | | |
| Total of these | | 100 | 100 |
| listed ingredients | | | |

According to certain methods of preparing a herbicide concentrate composition by first preparing a surfactant-inorganic acid solution, the surfactant-inorganic acid solution can be subsequently combined with a desired amount and type of acid herbicide, additional diluent if desired, and adjuvants (e.g., emulsifier) to produce the herbicide concentrate composition.

When inorganic acid is combined with other ingredients to form a herbicide concentrate composition or a precursor thereof (e.g., a surfactant-inorganic acid solution), e.g., combined with a amine surfactant and optional diluent, or combined with surfactant-acid herbicide solution, e.g., by methods described herein that involve the presence of not more than a low amount of water, the inorganic acid should not cause a substantial or undue negative effect in the resultant solution or concentrate, including that: the inorganic acid should not react with another ingredient of the composition such as the acid herbicide compound or the amine surfactant in a manner that causes more than an insubstantial amount of degradation; the inorganic acid should not cause the formation and precipitation of solid material; the inorganic acid should not produce coagulation of solid materials; the inorganic acid preferably does not produce a longlasting cloudy appearance; and the inorganic acid should not cause an undue viscosity increase, gumming, or other change in the rheology that would prevent the smooth flow of a resultant solution or concentrate such as during pumping at ambient temperature (e.g., 72 degrees Fahrenheit). Preferably the resultant liquid concentrate may by non-cloudy, clear and colorless, or may be non-cloudy and transparent but exhibiting some degree of coloration, e.g., light brown to brown coloration.

The amount of the inorganic acid in a concentrate as described can be an amount that is sufficient (based on the type and concentration of the acid) to cause the herbicide concentrate to be self-buffering, i.e., an amount that, when the concentrate is combined with multiple times (e.g., 2, 5, 10, or more) its volume of water, will result in a herbicide application composition having a pH that is below the pKa of the acid herbicide contained in the concentrate, e.g., a pH of below 5, 4.5, 4.0, 3.5, 3.0, 2.0, or lower.

According to certain preferred embodiments of described concentrates that include 2,4-D acid as the acid herbicide, the amount of inorganic acid in the concentrate can be sufficient to produce a liquid (aqueous) herbicide application composition that has a pH below about 2.8, e.g., below about 2.6 or below about 2.4. And when the inorganic acid in these concentrates is sulfuric acid, e.g., concentrated sulfuric acid, the amount of acid (including water contained in the acid) present in the concentrate can be in a range from 2 to 12 or 15 parts by weight concentrated sulfuric acid or from 3 to 8 parts by weight concentrated sulfuric acid, per 100 parts by weight concentrate; e.g., from 2 to 10 parts by weight percent concentrated sulfuric acid or from 4 to 8 weight percent concentrated sulfuric acid, based on 100 parts by weigh concentrate. As used herein, stated amounts of inorganic acid refer to the amount of total inorganic acid ingredient, including the amount of the acid material and the amount of any water contained in an inorganic acid ingredient.

The amount of the inorganic acid (including any water contained therein) in a concentrate relative to the amount of amine surfactant, optional diluent, and acid herbicide can be any relative amount useful to provide a desired concentrate as described, e.g., that is self-buffering, flowable, free of precipitate, etc. According to preferred concentrates the inorganic acid (including any water contained in the inorganic acid) can be present in a range from about 2 to 20, 3 to 18, 4 to 15, or 5 to 8, 10 or 12 parts by weight inorganic acid, per 20 to 50 or 25 to 40 parts by weight total amine surfactant and optional diluent, per 40 to 70 or 42 to 60 parts by weight acid herbicide, based on 100 parts by weight of the inorganic acid, amine surfactant, optional diluent, and acid herbicide.

According to specific concentrate embodiments that contain 2,4-D as the acid herbicide and sulfuric acid (e.g., concentrated sulfuric acid) as the inorganic acid, the amount of sulfuric acid in the concentrate can in a range from about 2 or 3 to about 8 or 10 parts by weight sulfuric acid (e.g., concentrated sulfuric acid); per 15 or 20 to 50, e.g., 25 to 40 parts by weight amine surfactant (e.g., tallow amine surfactant); per 2 to 20 or 5 to 15 parts by weight diluent (e.g., diethylene glycol); per at least 25 or 30 parts by weight acid herbicide, e.g., from 25 to 55 or from 30 to 50 parts by weight acid herbicide, based on 100 parts by weight inorganic acid, amine surfactant, optional diluent, and acid herbicide.

The concentrate can include minor ingredients as necessary or desired, such as an antifoam agent, a preservative, an antifreeze, antimicrobial agent, emulsifier, additional surfactant, a corrosion inhibitor, etc., as are known. If present, these can be included in the concentrate in amounts such that the total of these minor ingredients is less than 15, 10, 5, 3, 2, or 1 weight percent based on the total weight of the concentrate.

Example concentrates may consist of the acid herbicide, the amine surfactant, optional diluent, and the inorganic acid. Such a concentrate will contain no other added ingredient, including no added water, but may contain water that is present in one of these ingredients when the ingredient is added to the other ingredients to form the concentrate. Preferred such concentrates can contain no water or a low amount of water such as less than 10, 5, 3, 2, or 1, weight percent water based on total weight concentrate, from any source.

Other example concentrates may consist essentially of the acid herbicide, the amine surfactant, optional diluent, and the inorganic acid, meaning that the concentrate contains at least 85, 90, 95, 98, 99, or 99.5 weight percent acid herbicide, amine surfactant, optional diluent, and inorganic acid (including any amount of water present in the inorganic acid, and allowing for other impurities in these ingredients), and a total of below about 15, 10, 5 weight percent, e.g., less than 2 weight percent or less than 1 or 0.5 weight percent of other ingredients (which may be added water or another ingredient). Preferred such concentrates can contain no water other than any small amount of water present in the acid herbicide, amine surfactant, diluent, or inorganic acid ingredients used to form the concentrate, e.g., less than 5, 3, 2, or 1, weight percent water based on total weight concentrate, from any source.

The present concentrates and methods for preparing the present concentrates have been found to be capable of providing concentrate compositions having a relatively high amount (concentration) of acid herbicide compound in a self-buffering, liquid, acid herbicide concentrate, preferably with the concentrate also being in the form of a stable solution that is pumpable and flowable at ambient temperature. Examples of concentrates can contain at least about 2, e.g., 2.5 pounds of acid herbicide (e.g., 2,4-D) per gallon concentrate, preferably at least about 3.0, 3.5, 3.8, or up to or in excess of about 4, 5, or 6 pounds acid herbicide (e.g., 2,4-D) per gallon concentrate.

A concentrate as described can be prepared by any method found to be useful, including novel and inventive methods that have now been identified and are described herein. These new methods are capable of successfully preparing a herbicide concentrate that contains a high load (i.e., concentration) of acid-form herbicide, and a self-buffering amount of inorganic acid. Prior to the present description, efforts to incorporate a high concentration acidifying ingredient (e.g., inorganic acid to reduce pH of an application composition prepared by diluting the concentrate) into a liquid herbicide concentrate, have not succeeded in producing a concentrate that contains a sufficient amount of the acid to reduce the pH of a diluted concentrate to below a pH of an acid herbicide compound in the concentrate. Prior attempts have not resulted in herbicide concentrates that include a high concentration of acid herbicide (e.g., at least 2.5 or 3 pounds per gallon, or more), that are self-buffering, and that are flowable, and that are preferably storage stable.

Thus, according to certain methods now identified as being useful to prepare such a high load acid-herbicide concentrate, containing a high concentration of acid herbicide and an amount of acid to cause the concentrate to be self-buffering, amine surfactant and optional diluent can be first combined with the acid herbicide in the presence of a low amount of water, e.g., the acid herbicide is first dissolved in the amine surfactant and optional diluent in the presence of not more than a low or very low amount of water.

According to useful methods, the amount of water present in the surfactant and optional diluent, the amount of water present in the acid herbicide, and the amount of water otherwise present when combining the acid herbicide, amine surfactant, and optional diluent are low amounts, and each ingredient preferably contains no water or nearly no water. According to example steps of this method, a liquid anhydrous concentrated amine surfactant ingredient and optional liquid anhydrous diluent can be combined with solid anhydrous acid herbicide (such as a flake, granule, pellet, or the like), preferably in the presence of not more than a low amount of other ingredients or in the absence of other ingredients. The total amount of water present in the amine surfactant and diluent ingredients, and the acid herbicide ingredient, is very low, and no additional water is required to be added separately or as part of any other ingredient when mixing. The total amount of water present in combined ingredients is below about 5, 3, 2, 1, or 0.5 weight percent based on total weight of the ingredients being combined.

The step of combining the acid herbicide, amine surfactant, and optional diluent may be performed at ambient temperature or with heat sufficient to cause the solid acid herbicide to dissolve in the liquid amine surfactant and optional diluent, e.g., heating the amine surfactant and optional diluent to a temperature of at least 90, 100, 110, or 120 degrees Fahrenheit. The resultant surfactant-acid herbicide solution contains the acid herbicide dissolved in the liquid amine surfactant, optional diluent, and optional minor amounts of other ingredients, and below about 5, 3, 2, or 1 weight percent water from all sources. The surfactant-acid herbicide solution should contain no coagulated material, no remaining (undissolved) solid material, no precipitated solid material, and can preferably be transparent and non-cloudy (clear and colorless or optionally with slight coloration) in appearance. Preferred surfactant-acid herbicide solutions will remain free of coagulation, cloudiness, and precipitated solids for weeks (e.g., 3, 6, or 12 weeks) or months (e.g., 3, 6, or 8 months) when stored in a closed container at ambient temperature (e.g., 72 degrees Fahrenheit) without agitation.

After formation of the surfactant-acid herbicide solution, the inorganic acid is added to the surfactant-acid herbicide solution. This step can be performed with mixing, at ambient temperature and pressure, and by introducing the acid into the surfactant-acid herbicide solution in a manner that allows for even mixing.

Any minor ingredients desirably included in the concentrate may be added to the surfactant-acid herbicide solution, before the inorganic acid is added to the surfactant-acid herbicide solution, or alternately may be added to the concentrate after the inorganic acid is combined with the surfactant-acid herbicide solution.

The resultant concentrate solution contains the acid herbicide dissolved in the liquid amine surfactant, optional amounts of other minor ingredients, and can preferably contain less than 15, 10, 5, 3, 2, or 1 weight percent water (from all sources) based on the total weight of the concentrate. The concentrate should contain no coagulated material, no remaining (undissolved) solid material, no precipitated solid material, and can preferably exhibit a non-cloudy transparent (clear or with slight coloration) appearance. The viscosity and flow properties of the concentrate allow it to be poured or processed by pumping, and it is miscible with water.

According to other methods also now identified as being useful to prepare a high load acid-herbicide concentrate that contains a high concentration of acid herbicide and an amount of acid to cause the concentrate to be self-buffering, the amine surfactant and optional diluent are first combined with the inorganic acid in the presence of a low amount of water, e.g., the acid herbicide is first dissolved in the surfactant in the presence of not more than a low or very low amount of water.

According to useful methods, the amount of water present in the amine surfactant, optional diluent, the amount of water present in the inorganic acid, and the amount of water otherwise present when combining these ingredients is a low amount. According to preferred such steps of this method, a liquid anhydrous concentrated amine surfactant can be combined with optional liquid anhydrous diluent, and concentrated inorganic acid. The total amount of water present in the ingredients is very low, and no additional water is required to be added separately or as part of any other ingredient. The total amount of water present in combined ingredients is below about 10, 5, 3, 2, or 1, weight percent based on total weight of the ingredients being combined.

The step of combining the ingredients may be performed at ambient temperature or with heat, e.g., heating to a temperature of at least 90, 100, 110, or 120 degrees Fahrenheit. The resultant surfactant-inorganic acid solution contains the inorganic acid, the liquid amine surfactant and optional diluent, optional minor amounts of other ingredients, and below about 10, 5, 3, 2, or 1 weight percent water from all sources. The surfactant-inorganic acid solution should contain no coagulated material, no remaining (undissolved) solid material, no precipitated solid material, and can preferably be transparent and non-cloudy (clear and colorless or optionally with slight coloration) in appearance. Preferred surfactant-inorganic acid solutions will remain free of coagulation, cloudiness, and precipitated solids for weeks (e.g., 3, 6, or 12 weeks) or months (e.g., 3, 6, or 8 months) when stored in a closed container at ambient temperature (e.g., 72 degrees Fahrenheit) without agitation.

After formation of the surfactant-inorganic acid solution, the acid herbicide is added to the surfactant-inorganic acid solution. Optionally, additional diluent and minor ingredients can also be added. This step can be performed with mixing, at ambient temperature and pressure, and by introducing the acid herbicide and optional addition diluent into the surfactant-inorganic acid solution in a manner that allows for even mixing. Optionally, this step may be performed with heat sufficient to cause the solid acid herbicide to dissolve in the surfactant-inorganic acid solution, e.g., heating the amine surfactant and optional diluent to a temperature of at least 90, 100, 110, or 120 degrees Fahrenheit.

Any minor ingredients desirably included in the concentrate may be added to the surfactant-inorganic acid solution before the acid herbicide is added to the surfactant-inorganic acid solution, or alternately may be added to the concentrate after the acid herbicide is combined with the surfactant-inorganic acid solution.

The resultant concentrate solution contains the acid herbicide dissolved in liquid amine surfactant, inorganic acid, optional diluent, optional amounts of other minor ingredients, and can preferably contain less than 15, 10, 5, 3, 2, or 1 weight percent water (from all sources) based on the total weight of the concentrate. The concentrate should contain no coagulated material, no remaining (undissolved) solid material, no precipitated solid material, and can preferably exhibit a non-cloudy transparent (clear or with slight coloration) appearance. The viscosity and flow properties of the concentrate allow it to be poured or processed by pumping, and it is miscible with water.

Preferred concentrates prepared by any method can exhibit stability for a period of weeks or months without experiencing undue coagulation, viscosity build, or precipitation. For example, preferred concentrates are storage-stable for weeks (up to 12 weeks) or months (up to 3, 4, 5, or 6 months) at ambient temperature (72 degrees Fahrenheit) without forming precipitate, without coagulation, and while maintaining a form that remains flowable (pourable and pumpable).

### Example Concentrate Solutions

| | | Example ranges (parts by | |
|---|---|---|---|
| | | weight based on 100 parts | |
| | Example | by weight of these listed | |
| Ingredient | ingredient | ingredients) | |
| Amine Surfactant | Tallow amine | 15 to 40 or 50 | 20 to 35 |
| Diluent | Glycol, e.g., | 1 to 15 | 5 to 12 |
| | diethylene glycol | | |
| Diluent | Linear alcohol | 1 to 30 | 5 to 25 |
| Concentrated Acid | Concentrated | 2 to 12 | 2 to 10 |
| | sulfuric acid | | |
| Acid Herbicide | 2,4-D | 25 to 55 | 30 to 45 |
| Emulsifier | | Up to 6 | Up to 5 |
| Total of these | | 100 | 100 |
| listed ingredients | | | |

The concentrate can be combined with water to form an aqueous herbicide application composition. The herbicide application composition may take any useful form, with certain preferred forms being those of a solution, an emulsion, a microemulsion, or another form of flowable liquid that may be prepared in a tank by combining the concentrate with water. The resultant herbicide application composition may be applied to a field or to a plant or area of plants by spraying by passing the composition through a nozzle with pressure. Preferably, the herbicide application composition can be formed by combining the concentrate with water and other adjuvants (e.g., surfactant, emulsifier), active ingredients, or coformulants, and without adding acid in any substantial amount. The amount of acid in the concentrate is desirably sufficient to reduce the pH of the herbicide application composition to a desired level below the pKa of the active herbicide compound. There is preferably no need to add an additional amount of acid to the concentrate and water, when forming the herbicide application composition, for the purpose of reducing pH of the herbicide application composition. According to preferred methods of forming the application composition, a separate acid ingredient is not added to the concentrate to reduce the pH of the application composition to below the pKa of the active herbicide compound, e.g., not more than 0.5, 1, or 2 weight percent additional acid (based on the weight of the concentrate and water) is added to the concentrate and water used to form the herbicide application composition.

The amount of water combined with the concentrate can be any useful amount, and can be selected based on factors such as the concentration of acid herbicide in the concentrate, the concentration and strength of the inorganic acid (such that the herbicide application composition has a pH below a pKa of the acid herbicide), the application method (e.g., spraying), the desired concentration of acid herbicide in the herbicide application composition, the application rate, and the presence of co-herbicides or fertilizer in the herbicide application composition. Examples of useful relative amounts of water that may be combined with the concentrate can be in a range from about 1 to 100 parts by volume (e.g., gallons) water per 1 part by volume (e.g., gallon) concentrate, e.g., up to or in excess of 5, 8, 10, 20, 30, 40, 50, 60, 70, 80, or 90 parts by volume (e.g., gallons) water per 1 part by volume (e.g., gallon) concentrate. Certain embodiments of concentrate can be combined with water in an amount in a range from 0.5 or 1, to 10, 20, or 25 parts by volume (e.g., gallon) water per volume (gallon) concentrate.

A herbicide application composition as described can be applied for immediate vegetation control by contact killing, by application of the herbicide application composition to plants. The herbicide application composition can contain a useful amount of the acid herbicide based on factors of efficacy and safety, etc. Similarly, the amount of herbicide application composition applied to a plant or a field will be readily understood by those of skill, based, e.g., on desired efficacy, dosage, safety, and environmental factors.

The amount of acid herbicide compound in a herbicide application composition can be as desired based on factors that are known and described above, and in particular on the identity of the specific acid herbicide compound. Advantageously, it has been found that certain preferred herbicide application compositions of the invention, when applied at a pH below the pKa of the herbicide compound, can be applied at a lower dosage (i.e., a lower use rate, meaning a lower amount of the herbicide compound per plant or per acre) relative to a herbicide application composition containing the same active herbicide compound but not in the acid form, or relative to a herbicide application composition that contains the same active herbicide in the acid form but with the composition not having a pH below the pKa of the herbicide compound. For example, the increased unit activity of 2,4-D acid as compared to the 2,4-D amine salt (approximately a doubling of activity for the 2,4-D acid) will cause a use rate reduction of from 25 to 50 percent of the amount of 2,4-D acid ingredient compared to the amount of active ingredient needed if applied as the amine salt.

Examples of dosages of the acid herbicide compound to a plant or field, when the application composition exhibits a pH below the pKa of the acid herbicide (e.g., based on the inorganic acid contained in the concentrate) can be any useful dosage, such as a dosage in the range from about 1/100 or 1/10 to about 10 pounds acid herbicide compound per acre, with dosages in the range from about 1/100 or 1/10 to about 6 pounds acid herbicide compound per acre being sometimes preferred, e.g., from about 0.03 to 0.5 or 1 pound per acre. More resistant plants may require higher concentrations or a higher dosage rate.

Optionally, as desired, the concentrate can be combined into a herbicide application composition that contains one or more additional active ingredients such as an additional herbicide, pesticide, or fertilizer. Preferred concentrates can be mixed in a spray or other tank with many or most other pesticide (acid-form herbicides, or non-acid-form herbicides) to form a sprayable solution. Preferred concentrates can be especially suitable for tank mixing with an active herbicide or pesticide that is an acid herbicide (i.e., not a salt or ester). For example, 2,4-D amine salt should preferably not be tank mixed with a concentrate as described herein.

Most sulfonylurea herbicides should be applied within twenty-four hours after tank mixing with a concentrate of the present description. Otherwise there could be some loss of the sulfonylurea to acid mediated hydrolysis. All known sulfonylurea herbicides are stable for at least forty-eight hours in a mix with a concentrate as described herein. Most other pesticides will tank mix with a concentrate as described. Many anionic herbicides such as glyphosate, glufosinate, and the imidazolinones may exhibit enhanced herbicidal activity when mixed with a concentrate as described herein.

Preferred concentrates can also be mixed with a UAN (urea and ammonium nitrate) fertilizer, at least as well or preferably better than other 2,4-D formulations. It may be preferred that the herbicide application composition containing UAN and a diluted concentrate as described not be left to sit for more than twelve or twenty-four hours, e.g., overnight. Fertilizer burn with UAN may be a consideration, due to the potentially high level of surfactant in a concentrate or herbicide application composition as described herein. The potential of fertilizer burn and severity thereof may be evaluated with testing.

A concentrate as described can preferably tank mix well with micronutrient packages because an acid herbicide (e.g., the acid form of 2,4-D) is a neutral molecule and will not tie up with micronutrient cations.

The described concentrates and herbicide application compositions can be used for both immediate and long-term control of a large variety of vegetation including those usually found in agricultural fields such as bushes, scrub brush, vines, and other weeds. Illustrative of vegetation that can be controlled by these methods, depending significantly on the identity of the active herbicide compound, are: black mustard (brassica nigra), curly dock (rumex crispus), common groundsel (senecio vulgaris), pineapple weed (matricaria matricarioides), swamp smartweed (kelp) (polygonum coccineum), prickly lettus (lactuca scariola), lance-leaved groundcherry (physalis lanceifolia), annual sowthistle (sonchus oleraceus), london rocket (sisymbrium irio), common fiddleneck (amsinckia intermedia), hairy nightshade (solanum sarrachoides), shepherd's purse (capsella bursa-pastoris), sunflower (helianthus annus), common knotweed (polygonum aviculare), green amaranth (amaranthus hybridus), mare's tail (conyza canadensis), henbit (lamium amplexicaule), cocklebur (xanthium strumarium), cheeseweed (malva parviflora), lambsquarters (chenopodium album), puncture vine (tribulus terrestris) common purslane (portulaca oleracea), prostrate spurge (euphorbia supina), telegraph plant (heterotheca grandiflora), carpetweed (mollugo verticillata), yellow starthistle (centaurea solstitialis), milk thistle (silybum marianum), mayweed (anthemis cotula), burning nettle (urtica urens), fathen (atriplex patula), chickweed (stellaria media), scarlet pimpernel (anagallis arvensis) redroot pigweed (amaranthus retroflexus), minnerslettuce (montia perfoliata), turkey mullein (eremocarpus setigerus), nettleleaf goosefoot (chenopodium murale), prostrate pigweed (amaranthus blitoides), silverleaf nightshade (solanum elaeagnifolium), hoary cress (cardaria draba), largeseed dodder (cuscuta indecora), California burclover (medicago polymorpha), horse purslane (trianthema portulacastrum), field bindweed (Iconvolvulus arvensis), Russian knapweed (centaurea repens), flax-leaved fleabane (conyza bonariensis), wild radish (raphanus sativus), tumble pigweed (amaranthus albus), stephanomeria (stephanomeria exigua), wild turnip (brassica campestris), buffalo goard (cucurbita foetidissima), common mullein (verbascum thapsus), dandelion (taraxacum officinale), Spanish thistle (xanthium spinosum), chicory (cichorium intybus), sweet anise (foeniculum vulgare), annual yellow sweetclover (melilotus indica), poison hemlock (conium maculatum), broadleaf filaree (erodium botrys), whitestem filaree (erodium moschatum), redstem filaree (erodium cicutarium), ivyleaf morning-glory (ipomea hederacea), shortpod mustard (brassica geniculata), buckhorn plantain (plantago lacenolata), sticky chickweed (cerastium viscosum), himalaya blackberry (rubus procerus), purslane speedwell (veronica peregrina), Mexican tea (chenopodium ambrosioides), Spanish clover (lotus purshianus), Australian brassbuttons (cotula australis), goldenrod (solidago californica), citron (citrullus lanatus), hedge mustard (sisymbrium orientale), black nightshade (solanum nodiflorum), Chinese thornapple (datura ferox), bristly ox tongue (picris echioides), bull thistle (cirsium vulgare), spiny sowthistle (sonchus asper), Tasmanian goosefoot (chenopodium pumilio), goosefoot (chenopodium botrys), wright groundcherry (physalis acutifolia), tomatillo groundcherry (physalis philadelphica), pretty spurge (euphorbia peplus), bitter apple (cucumis myriocarpus), indian tobacco (nicotiana bigelovii), common morning-glory (ipomoea purpurea), waterplantain (alisma triviale), smartweed (polygonum lapathifolium), mature sowthistle (sonchus asper), yellow nutsedge (cyperus esculentus), purple nutsedge (cyperus rotundus), lupine (lupinus formosus), and grasses of the family Gramineae such as annual rye grass, blue grass, water grass, barnyard grass, bermuda grass, fescue, mat grass, Johnson grass, and the like.

Advantageously, preferred concentrates and herbicide application compositions as described herein can exhibit the additional advantage of being relatively non-volatile compared to other herbicide compositions. The advantage of a non-volatile herbicide composition will be appreciated by the skilled person in the herbicide chemicals arts. A non-volatile herbicide composition, after application to a plant or field, has the advantage of not evolving, or evolving to a reduced degree, through the air. The reduced volatility reduces the occurrence of inadvertent contact of the herbicide with adjacent or nearby, desired plant growth. In practical effect, this advantageous property allows a herbicide application composition as described to be applied to undesired plant growth in greater strength or in closer proximity to desired above-ground plant growth.

A herbicide application composition of the present description, containing acid herbicide and inorganic acid (present exclusively in the concentrate) in an amount to result in a self-buffering concentrate, can preferably exhibit a reduced level of off target crop injury compared to current herbicides containing a like herbicide compound in a non-acid form. Specifically regarding a composition having 2,4-D acid, the vapor pressure of 2,4-D acid is lower than that of an amine salt of 2,4-D and much lower than the low volatile ester formulations of 2,4-D. See Table 3, below.

TABLE 3
Vapor Pressure for Different Forms of 2,4-D

| Active Ingredient | Vapor Pressure |
|---|---|
| 2,4-D Iso-Octyl ester | 3.6 × 10−6 mmHg at 25 C. |
| 2,4-D Dimethylamine salt | <1 × 10−7 mmHg at 26 C. |
| 2,4-D Acid | 1.425 × 10−7 mmHg at 25 C. |

### EXAMPLES

Preparation of Surfactant-Acid Herbicide Solution

Concentrate compositions that contain acid herbicide, amine surfactant, and inorganic acid, can be prepared to contain a relatively high concentration of the active acid herbicide composition, including concentrations of 2,4-D that are unexpectedly high compared to previous methods of forming concentrates of 2,4-D acid herbicide.

By one method, a sample concentrate was prepared by combining 2,4-D acid flake at 4 lb/gal in an amine surfactant at a temperature of about 120 F (48 C). The heated combination of surfactant and acid herbicide (i.e., surfactant-acid herbicide solution) was in the form of a clear amber liquid. When cooled to room temperature the solution remained clear and stable, without precipitation or gelling. The formulation remained clear, non-gelled, and without precipitation or phase separation, for a year when stored at room temperature (e.g., 72 degrees Fahrenheit) without agitation.

Volatility

Volatility data for herbicide application compositions as described, containing 2,4-D acid, was generated using a bioassay in a plastic box container system. Bioassay plants, either tomato, soybeans or both, were grown in pots in a greenhouse. The bioassay plants were then placed inside the plastic container next to a specific 2,4-D treatment.

For comparison, samples were also prepared using a 2,4-D dimethyl amine salt (DMA); 2,4-D dimethyl amine salt (DMA) in combination with AMS (ammonium sulfate); 2,4-D ester; and 2,4-D acid (commercial form without acidifying agent).

A 20 milliliter (ml) aliquot of each type of 2,4-D tank mixture was placed in a glass petrie dish. One of the petrie dishes was then placed inside each box. The 20 milliliters of the 2,4-D spray solution was mixed with a volume of water to result in a 20 gal/Acre spray volume and a use rate of 0.25 pounds acid equivalent per acre, for each of the amine and acid active herbicide formulations. For the amine used in combination with AMS, the application simulated 17 pounds per 100 gallons.

The bioassay plants were placed in the box adjacent to the petrie dish. Plants were held in these plastic boxes adjacent to the petrie dish containing each of the different 2,4-D mixes for 24 hours, then placed away from the petrie dish and allowed to grow. Visual ratings were taken at 2 Days After Treatment (DAT) and 8 DAT. Epinasty, plant injury, was visually rated on a 0-10 scale, 10 being the highest. Epinasty injury to the bioassay plants was considered injury caused by vapors coming from the 2,4-D treatments in the petrie dish.

Using this testing method, the 2,4-D LV6 (commercial ester form) formulation always gave substantial injury, epinasty, via the vapor phase. The amine salt formulations would, at times, show some epinasty, slight epinasty or no epinasty. Herbicide application compositions prepared from a concentrate as describe herein would at times show slight epinasty. The number of trials that showed epinasty or did not show epinasty by formulation type and the range of the epinasty rating is in Table 4:

TABLE 4

| | | Trials | Trials | Range of |
|---|---|---|---|---|
| | Total | with | with no | Epinasty |
| Formulation Type | Trials | Epinasty | Epinasty | Rating* |
| 2,4-D DMA | 16 | 8 | 8 | 0-1 |
| 2,4 D DMA + AMS | 12 | 11 | 1 | 1-3 |
| 2,4-D LV6 (2,4-D ester) | 11 | 11 | 0 | 5-8 |
| 2,4-D Acid Commercial | 9 | 8 | 1 | 0-1 |
| 2,4-D Acid (from | 7 | 2 | 5 | 0-0.25 |
| inventive concentrate) | | | | |

As shown at Table 4, the LV6 (2,4-D ester) ester herbicide caused the most injury from vapors. Injury occurred in all 11 trials and the lowest rating (5) was higher than any of the ratings for the other formulations. The ratings for the 2,4-D amine (DMA) examples were low and similar to those seen with the 2,4-D acid formulations. The least amount of vapor injury was seen with the herbicide application compositions prepared by combining water with a self-buffering concentrate as described herein. This indicates that acid formulations are indeed less volatile as suggested by their vapor pressures (Table 3). This is more demonstrative due to the activity difference between 2,4-D amine salt and the 2,4-D acid formulations, the 2,4-D amine salt having lower activity as compared to the 2,4-D acid.

The herbicidal activity (or efficacy) of an inventive herbicide application composition prepared by combining water with a self-buffering concentrate as described herein can be approximately double (two times) that of the DMA 2,4-D salt. So in practical application, the use rate for a herbicide application composition of the invention, containing 2,4-D acid at low pH, would be 25% to 50% lower than a DMA salt of 2,4-D on an acid equivalent basis. As a general matter, in these trials, the 2,4-D ester was found to cause the highest degree of epinasty, a lesser (e.g., slight) amount of epinasty was caused using the 2,4-D DMA salts, and the lowest amount of epinasty (e.g., no damage) occurred by use of a herbicide application compositions prepared by combining water with a self-buffering concentrate as described herein to form a low pH 2,4-D acid herbicide application composition.

Similar example herbicide formulations were tested in a separate trial to simulate a use rate of 0.75 pounds (ae) per acre, also applied at 20 gallons per acre. The amount of injury seen with the 2,4-D amine formulation was dramatically higher than what was observed at the lower use rate (0.25 or 0.5 pounds (ae) per acre at 20 gallons per acre). The increased use rate doubles or triples the amount (concentration) of active 2,4-D in a spray solution treatment. The amount of vapor injury increased as well. The injury increase was much more dramatic with the DMA salt of 2,4-D, indicating that 2,4-D DMA is more prone to volatility than is the 2,4-D acid compound of the self-buffering 2,4-D acid formulations of the present description.

It should be noted that the self-buffering acid herbicide concentrates described herein exhibit increased effectiveness (e.g., may be twice as active or effective) as compared to the DMA salt (when comparing efficacy of the same concentrations of active herbicide compound) when directly applied to most plants. However, it is unknown which chemical form of 2,4-D is in a vapor phase with either DMA salt or the self-buffering acid formulations described herein. Based on the injury results of these presented trials, it can be inferred that more 2,4-D was in the vapor phase with the DMA salt formulation than with the described self-buffering acid formulations.

In theory, both types of treatments likely release negatively charged 2,4 dichlorophenoxy acetic acid. However, at the use rate tested, based on the observed amounts of injury for the different formulations, the likely amount of 2,4-D transferring from the spray solution to the vapor phase is dramatically higher for the DMA salt of 2,4-D as compared to the described self-buffering 2,4-D acid formulation. This is not unexpected, as the vapor pressure for 2,4-D acid is much lower than the vapor pressure of a 2,4-D ester, and is also lower than the vapor pressure of the 2,4-D amine salt. The results of these tests are not included in Table 4 because of the use rate differences.

Efficacy

An advantage of using 2,4-D in the acid form is its increased herbicidal activity relative to other chemical forms of 2,4-D (e.g., salt or ester forms). The challenge has been to formulate 2,4-D acid in a manner to consistently apply the acid to plants. The described self-buffering concentrates containing acid herbicide (e.g., 2,4-D acid) and inorganic acid are not only an acid form of a herbicide (e.g., 2,4-D acid) but also contain an amount of acid to maintain the pH of a diluted concentration below the pKa of the 2,4-D acid, improving efficacy of the acid herbicide compound. Self-buffering is important to maintain consistent performance by ensuring a desirably low pH upon mixing and during use. Other 2,4-D acid formulations that are non-self-buffering require the addition of an acidifying adjuvant to maintain the unit activity of the 2,4-D acid. This can lead to variability in pH when applied.

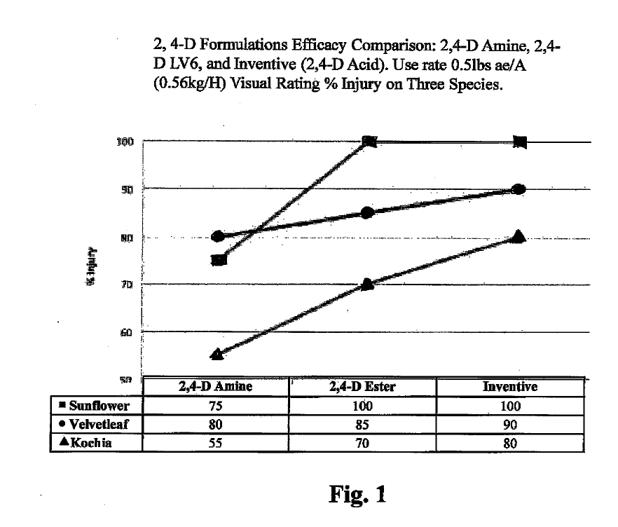

Herbicide activity comparisons of the inventive self-buffering 2,4-D acid herbicide compositions should be made with an appreciation that its environmental profile is closer to that of the 2,4-D amine salts rather than the 2,4-D esters. The volatility profile of the described self-buffering 2,4-D acid herbicide compositions is less than 2,4-D amine compositions, and the soil profile will be very close to that of an application of the amine salt. Because self-buffering 2,4-D acid herbicide compositions, and salt formulations of 2,4-D, will occupy a similar environmental niche, the activity comparisons between these two formulation types is important. The environmental profile will determine application regulations, and activity will determine the use rates. The herbicidal activity of self-buffering 2,4-D acid herbicide composition (“Inventive”) as described can be generally twice that of the amine salt formulations of 2,4-D. See FIG. 1.

Referring to FIG. 1, at the same rate of 0.5 lb ae/Acre the herbicidal activity (percent injury) is higher for the described (Inventive) self-buffering 2,4-D acid herbicide compositions, as compared to the 2,4-D DMA formulation, on the three species tested. The herbicidal activity of the described (Inventive) self-buffering 2,4-D acid herbicide compositions is also slightly more active than LV6 (2,4-D ester) in this test. These results show a key advantage of the inventive self-buffering acid herbicide formulations, at least when the acid herbicide is 2,4-D acid, which is that the inventive composition can exhibit the same environmental properties of the amine salt, with much higher activity. The activity of the 2,4-D acid in the inventive composition can be similar to or better than the activity seen with low volatile esters.

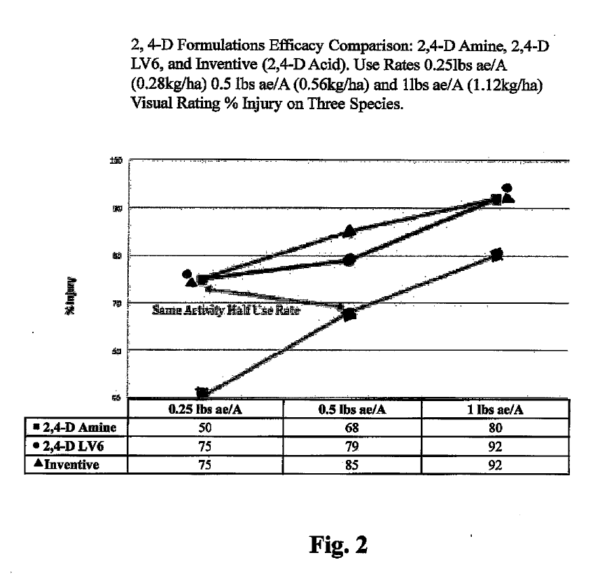

FIG. 2 shows herbicidal activity (percent injury) over a range of use rates. The activity of the Inventive formulation exceeds that of the 2,4-D amine at all use rates.

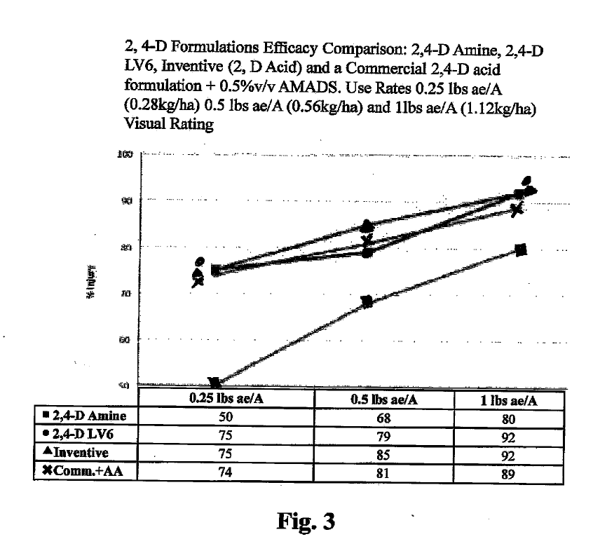

At FIG. 3, the performance of the commercial 2,4-D formulation with added acidifying agent (AA), and the Inventive formulation, are shown to be better than the performance of the amine salt formulation, and similar to the performance of the low volatile ester. Advantageously, the Inventive formulation did not require addition of acidifying agent to the tank mix.

1. A herbicide concentrate composition comprising:
amine surfactant,
inorganic acid,
acid herbicide, and
less than 10 weight percent water.

2. A herbicide concentrate of claim 1 wherein the concentrate is a homogeneous solution, the acid herbicide being completely dissolved and the concentrate containing solids or suspended material.

3. A herbicide concentrate composition as recited at claim 1 comprising diluent effective to reduce a viscosity of the concentrate composition.

4. A herbicide concentrate composition of claim 3 having a viscosity below 500 centipoise.

5. A herbicide concentrate composition of claim 3 wherein the diluent is an oil, non-ionic surfactant, alkyl alcohol, polyol, or a glycol.

6. A herbicide concentrate composition as recited at claim 1 comprising:
from 25 to 40 parts by weight amine surfactant,
from 0 to 20 parts by weight diluent,
from 2 to 12 parts by weight inorganic acid, and
at least 30 parts by weight acid herbicide,
based on 100 parts by weight concentrate.

7. A herbicide concentrate composition as recited at claim 6 comprising from 25 to 40 parts by weight total amine surfactant and diluent.

8. A herbicide concentrate composition as recited at claim 3 wherein the amine surfactant is a tallow amine surfactant and the diluent is a glycol.

9. (canceled)

10. A herbicide concentrate composition as recited at claim 1 comprising from 2 to 6 pounds acid herbicide per gallon.

11. A herbicide concentrate composition as recited at claim 1 wherein the amine surfactant is a tallow amine surfactant.

12. A herbicide concentrate composition as recited at claim 1 wherein the inorganic acid is concentrated sulfuric acid.

13-15. (canceled)

16. A herbicide concentrate composition as recited at claim 1 wherein the composition can be stored at 70 degrees Fahrenheit for 3 months without solid precipitate forming in the composition.

17. A herbicide application composition comprising
a herbicide concentrate composition as recited at claim 1, and
from 2 to 30 gallons added water per gallon herbicide concentrate composition.

18. (canceled)

19. A herbicide application composition as recited at claim 17 wherein the application composition has pH below a pKa of the acid herbicide.

20. A herbicide application composition as recited at claim 17 wherein the acid herbicide is 2,4-D and the pH is below about 2.8.

21. (canceled)

22. A method of preparing a herbicide concentrate composition, the method comprising
providing amine surfactant and optional diluent,
providing acid herbicide,
providing inorganic acid, and
combining the amine surfactant with the acid herbicide and inorganic acid to produce a herbicide concentrate composition.

23-30. (canceled)

31. A method as recited at claim 22 comprising combining:
from 20 to 70 parts by weight liquid amine surfactant, with
from 20 to 70 parts by weight acid herbicide,
based on 100 parts by weight total liquid amine surfactant and acid herbicide,
to form a solution that contains the liquid amine surfactant, acid herbicide, and not more than 2 weight percent water.

32. (canceled)

33. (canceled)

34. A surfactant-inorganic acid solution comprising:
from 70 to 97 parts by weight amine surfactant, and
from 3 to 30 parts by weight inorganic acid,
based on 100 parts by weight amine surfactant and acid herbicide,
the solution containing not more than 10 weight percent water.

35. A solution of claim 34 wherein the amine surfactant is a tallow amine surfactant and the acid herbicide is 2,4-D acid herbicide.

36-41. (canceled)
